(19) United States
(12) Patent Application Publication
(10) Pub. No.: US 2025/0379385 A1
(43) Pub. Date: Dec. 11, 2025

(54) CONNECTOR AND CONNECTOR SET

(71) Applicant: Murata Manufacturing Co., Ltd., Kyoto-fu (JP)

(72) Inventors: Shingo ABO, Nagaokakyo-shi (JP); Yuuto MORITA, Nagaokakyo-shi (JP)

(73) Assignee: Murata Manufacturing Co., Ltd., Kyoto-fu (JP)

(21) Appl. No.: 19/308,872

(22) Filed: Aug. 25, 2025

Related U.S. Application Data
(63) Continuation of application No. PCT/JP2024/002412, filed on Jan. 26, 2024.

(30) Foreign Application Priority Data
Feb. 27, 2023 (JP) 2023-028206

(51) Int. Cl. H01R 13/02; H01R 12/71; H01R 13/405

(52) U.S. Cl. CPC H01R 13/02; H01R 12/716; H01R 13/405

(57) ABSTRACT

A connector includes a resin body member and one or more first outer connection terminals supported by the resin body member. The one or more first outer connection terminals each include a main body portion including a first portion that extends in an up-down direction, a second portion, above the first portion, that extends in a left-right direction, a third portion, below the second portion, that extends in the up-down direction, a first coupling portion that is bent and physically connects an upper-end portion of the first portion and a left-end portion of the second portion to each other, and a second coupling portion that is bent and physically connects a right-end portion of the second portion and an upper-end portion of the third portion to each other. A second front or rear surface is connected to a first inner peripheral surface via one or more chamfered portions.

### CROSS-REFERENCE TO RELATED APPLICATIONS

This application claims benefit of priority to International Patent Application No. PCT/JP2024/002412, filed Jan. 26, 2024, and to Japanese Patent Application No. 2023-028206, filed Feb. 27, 2023, the entire contents of each are incorporated herein by reference.

### BACKGROUND

### Technical Field

The present disclosure relates to a connector and a connector set.

### Background Art

An disclosure that relates to conventional connectors is, for example, the electrical connector described in Japanese Patent No. 5458042. The electrical connector described in Japanese Patent No. 5458042 includes a housing made of an electrical insulating material and metal terminals held by the housing. The terminals are produced by metal plates being bent. The terminals make contact with corresponding terminals of the mating connector when coupled to the mating connector.

### SUMMARY

In the field of the electrical connector described in Japanese Patent No. 5458042, there is a desire to suppress the concentration of stress on portions of the terminals when coupled to the mating connector.

Accordingly, the present disclosure provides a connector that can suppress the concentration of stress on portions of the terminals when coupled to the mating connector.

A connector according to an embodiment of the present disclosure includes a resin body member; and one or more first outer connection terminals supported by the resin body member. The one or more first outer connection terminal each include a main body portion including a first portion that extends in an up-down direction, a second portion, located above the first portion, that extends in a left-right direction, a third portion, located below the second portion, that extends in the up-down direction, a first coupling portion that is bent and physically connects an upper-end portion of the first portion and a left-end portion of the second portion to each other, and a second coupling portion that is bent and physically connects a right-end portion of the second portion and an upper-end portion of the third portion to each other. The second portion has a lower surface, a second front surface, and a second rear surface. The first portion has a right surface. The first coupling portion has a first inner peripheral surface that faces a lower-right direction, a third front surface, and a third rear surface. The second coupling portion has a second inner peripheral surface that faces a lower-left direction, a fourth front surface, and a fourth rear surface. The third portion has a left surface. The second front surface or the second rear surface is connected to the lower surface via one or more chamfered portions, the third front surface or the third rear surface is connected to the first inner peripheral surface via one or more chamfered portions, or the fourth front surface or the fourth rear surface is connected to the second inner peripheral surface via one or more chamfered portions. Also, the right surface, the lower surface, the left surface, the one or more chamfered portions, and the first inner peripheral surface or the second inner peripheral surface are in contact with the resin body member.

The connector according to the present disclosure can suppress the concentration of stress on portions of the terminals when coupled to the mating connector.

### BRIEF DESCRIPTION OF THE DRAWINGS

FIG. 1 is a perspective view of a connector set according to a first embodiment;

FIG. 2 is a perspective view of a first connector according to the first embodiment;

FIG. 3 is a perspective view of first signal terminals and first ground terminals of the first connector according to the first embodiment;

FIG. 4 is a perspective view of the first signal terminal according to the first embodiment;

FIG. 5 is a cross-sectional view of the signal terminal and a frame portion according to the first embodiment;

FIG. 6 is a perspective view of a first ground terminal according to the first embodiment;

FIG. 7 is a cross-sectional view of the first ground terminal and the frame portion according to the first embodiment;

FIG. 8 is a perspective view of a second connector according to the first embodiment;

FIG. 9 is a perspective view of second signal terminals and second ground terminals of the second connector according to the first embodiment;

FIG. 10 is a cross-sectional view illustrating damage to a resin body member caused by contact between a first signal terminal and the second signal terminal;

FIG. 11 is a perspective view of the first signal terminal according to a first modification;

FIG. 12 is a cross-sectional view of a first chamfered portion, a second chamfered portion, a third chamfered portion, and a fourth chamfered portion according to a second modification, as viewed in a left direction;

FIG. 13 is a cross-sectional view of the right end of a first coupling portion and the frame portion according to a third modification, as viewed in the left direction;

FIG. 14 is a cross-sectional view of the left end of a second coupling portion and the frame portion according to the third modification, as viewed in the left direction;

FIG. 15 is a cross-sectional view of the right end of the first coupling portion and the frame portion according to a fourth modification, as viewed in the left direction; and

FIG. 16 is a cross-sectional view of the left end of the second coupling portion and the frame portion according to the fourth modification, as viewed in the left direction.

### DETAILED DESCRIPTION

### First Embodiment

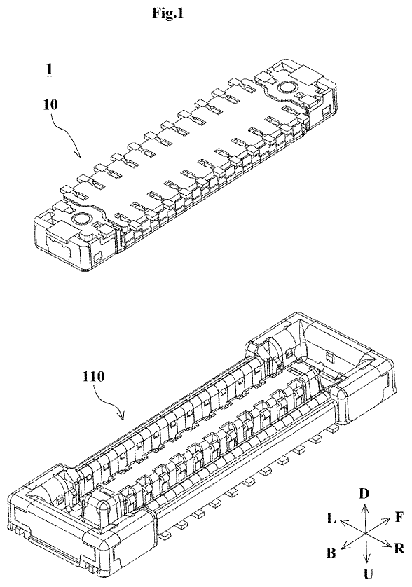

A connector set 1 including a first connector 10 according to a first embodiment of the present disclosure will be described below with reference to the drawings. FIG. 1 is a perspective view of the connector set 1 according to the first embodiment.

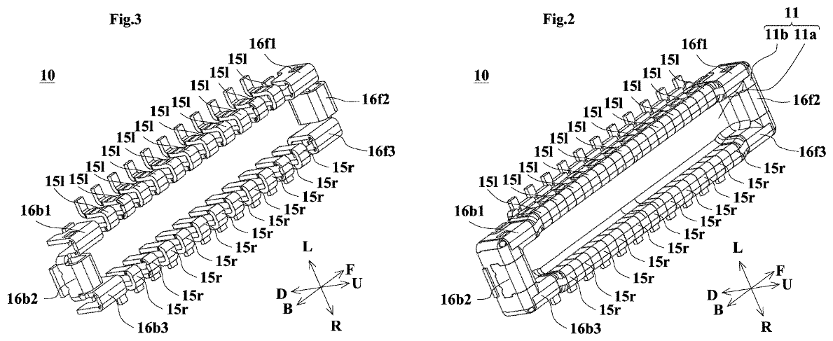

In this specification, directions are defined as described below. As illustrated in FIG. 1, the direction from a second connector 110 to the first connector 10 is defined as a downward direction. In addition, the direction opposite to the downward direction is defined as an upward direction. In addition, as illustrated in FIG. 2, the direction in which first signal terminals 151 are arranged in the first connector 10 is defined as a forward direction. The direction opposite to the forward direction is defined as a backward direction. A front-rear axis is orthogonal to an up-down axis. In addition, the axis orthogonal to the up-down axis and the front-rear axis is defined as a left-right axis. However, the up-down axis, the front-rear axis, and the left-right axis in this specification are defined for the convenience of description and do not necessarily need to correspond to the up-down axis, the front-rear axis, and the left-right axis during use of the connector set 1. In addition, in the drawings, the upward direction and the downward direction may be interchanged, the left direction and the right direction may be interchanged, and the forward direction and the backward direction may be interchanged.

In this specification, the positional relationship between members is defined as described below. First to third members are components of the connector set 1. When it is stated in this specification that the first member is disposed on the second member, the following state is indicated. At least a portion of the first member is located directly above the second member. Accordingly, the first member overlaps the second member as viewed in the downward direction. This definition applies to directions other than the upward direction.

When it is stated in this specification that the first member is disposed above the second member, the case in which at least a portion of the first member is located directly above the second member and the case in which the first member is not located directly above the second member and the first member is located diagonally above the second member are included. In this case, the first member does not need to overlap the second member as viewed in the downward direction. “Diagonally above” refers to, for example, “upper left”, “upper right”, or the like. This definition also applies to directions other than the upward direction.

In this specification, unless otherwise specified, portions of the first member are defined as described below. The front portion of the first member refers to the front half of the first member. The front end of the first member refers to the end of the first member located in the forward direction. The front-end portion of the first member refers to the front end of the first member and the vicinity thereof. This definition also applies to directions other than the forward direction.

When any two members in this specification are defined as a first member and a second member, the relationship between any two members will have the meaning described below. When it is stated in this specification that the first member is supported by the second member, the case in which the first member is attached to the second member in an unmovable manner (that is, a fixed manner) with respect to the second member and the case in which the first member is attached to the second member in a movable manner with respect to the second member are included. In addition, when it is stated that the first member is supported by the second member, the case in which the first member is directly attached to the second member and the case in which the first member is attached to the second member via the third member are included.

When it is stated in this specification that the first member is held by the second member, the case in which the first member is attached to the second member in an unmovable manner (that is, a fixed manner) with respect to the second member is included, and the case in which the first member is attached to the second member in a movable manner with respect to the second member is not included. In addition, when it is stated that the first member is held by the second member, the case in which the first member is directly attached to the second member and the case in which the first member is attached to the second member via the third member are included.

When it is stated that in this specification that the first member and the second member are electrically connected to each other, electrical conduction between the first member and the second member is present. Accordingly, the first member may be in contact with the second member, or the first member does not need to be in contact with the second member. When the first member is not in contact with the second member, the third member having conductivity is disposed between the first member and the second member.

An axis or a member that extends in the up-down direction in this specification refers to an axis or a member that is inclined within a range of +45° with respect to the up-down direction. Similarly, an axis or a member that extends in the front-rear direction does not necessarily refer only an axis or a member that are parallel to the front-rear direction. An axis or a member that extends in the front-rear direction refers to an axis or a member that is inclined within a range of +45° with respect to the front-rear direction. An axis or a member that extends in the left-right direction refers to an axis or a member that is inclined within a range of +45° with respect to the left-right direction.

The connector set 1 is used, for example, to connect two circuit boards. The connector set 1 includes the first connector 10 and the second connector 110, as illustrated in FIG. 1. When the first connector 10 and the second connector 110 are coupled to each other, the first connector 10 is located below the second connector 110. [Structure of First Connector]

Next, the structure of the first connector 10 will be described with reference to the drawings. FIG. 2 is a perspective view of the first connector 10 according to the first embodiment. FIG. 3 is a perspective view of first signal terminals 151 and 15r and first ground terminals 16b1 to 16b3 and 16f1 to 16f3 of the first connector 10 according to the first embodiment.

The first connector 10 includes a resin body member 11, the first signal terminals 151 and 15r, and the first ground terminals 16b1 to 16b3 and 16f1 to 16f3, as illustrated in FIGS. 2 and 3. The resin body member 11, the first signal terminals 151 and 15r, and the first ground terminals 16b1 to 16b3 and 16f1 to 16f3 are molded integrally with each other by insert molding. The first signal terminals 151 and 15r and the first ground terminals 16b1 to 16b3 and 16f1 to 16f3 correspond to the first outer connection terminal.

The resin body member 11 includes a bottom surface portion 11a and the frame portion 11b, as illustrated in FIG. 2. The frame portion 11b has a loop shape as viewed in the downward direction. More specifically, the frame portion 11b has a rectangular outer edge and a rectangular inner edge as viewed in the downward direction. The outer edge of the frame portion 11b and the inner edge of the frame portion 11b each have a left side and a right side that extend along the front-rear axis, and a front side and a rear side that extend along the left-right axis, as viewed in the downward direction. The bottom surface portion 11a blocks the lower surface of the region surrounded by the frame portion 11b, as viewed in the downward direction. The material of the resin body member 11 is an insulating material. The material of the resin body member 11 is, for example, a resin.

High-frequency signals are input or output through the first signal terminals 151 and 15r. The first signal terminals 151 and 15r are supported by the resin body member 11. More specifically, portions of the first signal terminal 151 are embedded in the left side of the frame portion 11b. The first signal terminals 151 are arranged in a line along the front-rear axis. The resin body member 11 is present between adjacent first signal terminals 151. In addition, portions of the first signal terminals 15r are embedded in the right side of the frame portion 11b. The first signal terminals 15r are arranged in a line along the front-rear axis. The resin body member 11 is present between adjacent first signal terminals 15r. The first signal terminals 151 and 15r are produced by rod-shaped metal members being bent. The material of the first signal terminals 151 and 15r is, for example, a copper-based material, such as phosphor bronze.

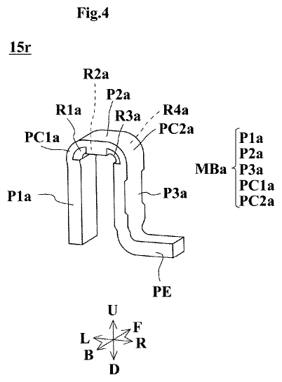

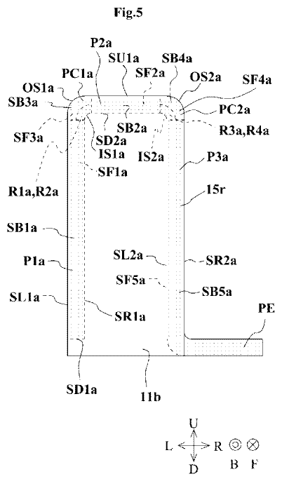

The structure of the first signal terminals 151 and 15r will be described in detail with reference to the drawings. It should be noted that, since the first signal terminal 151 has a structure that is symmetrical with respect to the first signal terminal 15r in the left-right direction, the description thereof is omitted. FIG. 4 is a perspective view of the first signal terminal 15r according to the first embodiment. FIG. 5 is a cross-sectional view of the first signal terminal 15r and the frame portion 11b according to the first embodiment.

The first signal terminal 15r includes a main body portion MBa and an exposed portion PE, as illustrated in FIGS. 4 and 5. The main body portion MBa includes a first portion Pla, a second portion P2a, a third portion P3a, a first coupling portion PCla, and a second coupling portion PC2a.

The first portion Pla has a first left surface SL1a that faces the left direction, a first right surface SR1a that faces the right direction, a first rear surface SB1a and a first front surface SF1a that are arranged in the front-rear direction, and a first lower surface SD1a that faces the downward direction. The first left surface SL1a is not in contact with the resin body member 11. Accordingly, the first left surface SL1a is exposed from the resin body member 11. The first right surface SR1a, the first rear surface SB1a, the first front surface SF1a, and the first lower surface SD1a are in contact with the frame portion 11b. Accordingly, the first right surface SR1a, the first rear surface SB1a, the first front surface SF1a, and the first lower surface SD1a are in contact with the resin body member 11. The first portion Pla extends in the up-down direction. In addition, in the embodiment, the length of the first portion Pla in the left-right direction is uniform.

The second portion P2a is located above the first portion Pla. The second portion P2a has a second rear surface SB2a and a second front surface SF2a that are arranged in the front-rear direction, a first upper surface SU1a that faces the upward direction, and a second lower surface SD2a that faces the downward direction. The first upper surface SU1a is not in contact with the resin body member 11. Accordingly, the first upper surface SU1a is exposed from the resin body member 11. The second rear surface SB2a, the second front surface SF2a, and the second lower surface SD2a are in contact with the frame portion 11b. Accordingly, the second rear surface SB2a, the second front surface SF2a, and the second lower surface SD2a are in contact with the resin body member 11. The second portion P2a extends in the left-right direction. In the embodiment, the length of the second portion P2a in the up-down direction is uniform.

The third portion P3a is located below the second portion P2a. The third portion P3a has a second left surface SL2a that faces the left direction, a second right surface SR2a that faces the right direction, and a fifth rear surface SB5a and a fifth front surface SF5a that are arranged in the front-rear direction. The second right surface SR2a is not in contact with the resin body member 11. Accordingly, the second right surface SR2a is exposed from the resin body member 11. The second left surface SL2a, the fifth rear surface SB5a, the fifth front surface SF5a, and the second lower surface SD2a are in contact with the frame portion 11b. Accordingly, the second left surface SL2a, the fifth rear surface SB5a, the fifth front surface SF5a, and the second lower surface SD2a are in contact with the resin body member 11. The third portion P3a extends in the up-down direction. In addition, in the embodiment, the length of the third portion P3a in the left-right direction is uniform.

The first coupling portion PCla physically connects the upper-end portion of the first portion Pla and the left-end portion of the second portion P2a to each other and is bent. The first coupling portion PCla has a first inner peripheral surface IS1a that faces the lower-right direction, a first outer peripheral surface OS1a that faces the upper-left direction, and a third rear surface SB3a and a third front surface SF3a that are arranged in the front-rear direction. The first inner peripheral surface IS1a is connected to the first right surface SR1a and the second lower surface SD2a. The first outer peripheral surface OS1a is connected to the first left surface SL1a and the first upper surface SU1a. The third rear surface SB3a is connected to the first rear surface SB1a and the second rear surface SB2a. The third front surface SF3a is connected to the first front surface SF1a and the second front surface SF2a. The first outer peripheral surface OS1a is not in contact with the resin body member 11. Accordingly, the first outer peripheral surface OS1a is exposed from the resin body member 11. The first inner peripheral surface IS1a, the third rear surface SB3a, and the third front surface SF3a are in contact with the frame portion 11b. Accordingly, the first inner peripheral surface IS1a, the third rear surface SB3a, and the third front surface SF3a are in contact with the resin body member 11.

The second coupling portion PC2a physically connects the right-end portion of the second portion P2a and the upper-end portion of the third portion P3a to each other and is bent. The second coupling portion PC2a has a second inner peripheral surface IS2a that faces the lower-left direction, a second outer peripheral surface OS2a that faces the upper-right direction, and a fourth rear surface SB4a and a fourth front surface SF4a that are arranged in the front-rear direction. The second inner peripheral surface IS2a is connected to the second lower surface SD2a and the second left surface SL2a. The second outer peripheral surface OS2a is connected to the first upper surface SU1a and the second right surface SR2a. The fourth rear surface SB4a is connected to the second rear surface SB2a and the fifth rear surface SB5a. The fourth front surface SF4a is connected to the second front surface SF2a and the fifth front surface SF5a. The second outer peripheral surface OS2a is not in contact with the resin body member 11. Accordingly, the second outer peripheral surface OS2a is exposed from the resin body member 11. The second inner peripheral surface IS2a, the fourth rear surface SB4a, and the fourth front surface SF4a are in contact with the frame portion 11b. Accordingly, the second inner peripheral surface IS2a, the fourth rear surface SB4a, and the fourth front surface SF4a are in contact with the resin body member 11.

In the embodiment, as illustrated in FIG. 4, a first chamfered portion R1a and a second chamfered portion R2a are provided in the first coupling portion PCla. In addition, a third chamfered portion R3a and a fourth chamfered portion R4a are provided in the second coupling portion PC2a. It should be noted that the second chamfered portion R2a has a structure that is symmetrical with respect to the first chamfered portion R1a in the front-rear direction. In addition, the fourth chamfered portion R4a has a structure that is symmetrical with respect to the third chamfered portion R3a in the front-rear direction. In the embodiment, the first chamfered portion R1a, the second chamfered portion R2a, the third chamfered portion R3a, and the fourth chamfered portion R4a are not connected to each other. The chamfered portions have, for example, a shape connected by a flat surface through a beveled corner, a shape connected by a convex curved surface through a beveled corner, or a shape connected by a concave curved surface through a beveled corner.

The third rear surface SB3a is connected to the first inner peripheral surface IS1a via the first chamfered portion R1a. More specifically, the first chamfered portion R1a is recessed in the left direction as viewed in the front-rear direction. In addition, the first chamfered portion R1a is recessed in the forward direction as viewed in the left-right direction. Accordingly, as illustrated in FIG. 5, the first chamfered portion R1a is recessed in the direction from the first inner peripheral surface IS1a to the first outer peripheral surface OS1a as viewed in the front-rear direction. However, as illustrated in FIG. 4, the first chamfered portion R1a does not reach the third front surface SF3a. Since the first chamfered portion R1a is provided, the thickness of the rear-end portion of the first coupling portion PCla is reduced. The first chamfered portion R1a is in contact with the frame portion 11b. Accordingly, the first chamfered portion R1a is in contact with the resin body

The third front surface SF3a is connected to the first inner peripheral surface IS1a via the second chamfered portion R2a. More specifically, the second chamfered portion R2a is recessed in the left direction as viewed in the front-rear direction. In addition, the second chamfered portion R2a is recessed in the backward direction as viewed in the left-right direction. Accordingly, as illustrated in FIG. 5, the second chamfered portion R2a is recessed in the direction from the first inner peripheral surface IS1a to the first outer peripheral surface OS1a as viewed in the front-rear direction. However, as illustrated in FIG. 4, the second chamfered portion R2a does not reach the third rear surface SB3a. Since the second chamfered portion R2a is provided, the thickness of the front-end portion of the first coupling portion PCla is reduced. The second chamfered portion R2a is in contact with the frame portion 11b. Accordingly, the second chamfered portion R2a is in contact with the resin body member 11.

The fourth rear surface SB4a is connected to the second inner peripheral surface IS2a via the third chamfered portion R3a. More specifically, the third chamfered portion R3a is recessed in the right direction as viewed in the front-rear direction. In addition, the third chamfered portion R3a is recessed in the forward direction as viewed in the left-right direction. Accordingly, as illustrated in FIG. 5, the third chamfered portion R3a is recessed in the direction from the second inner peripheral surface IS2a to the second outer peripheral surface OS2a as viewed in the front-rear direction. However, as illustrated in FIG. 4, the third chamfered portion R3a does not reach the fourth front surface SF4a. Since the third chamfered portion R3a is provided, the thickness of the rear-end portion of the second coupling portion PC2a is reduced. The third chamfered portion R3a is in contact with the frame portion 11b. Accordingly, the third chamfered portion R3a is in contact with the resin body member 11.

The fourth front surface SF4a is connected to the second inner peripheral surface IS2a via the fourth chamfered portion R4a. More specifically, the fourth chamfered portion R4a is recessed in the right direction as viewed in the front-rear direction. In addition, the fourth chamfered portion R4a is recessed in the backward direction as viewed in the left-right direction. Accordingly, as illustrated in FIG. 5, the fourth chamfered portion R4a is recessed in the direction from the second inner peripheral surface IS2a to the second outer peripheral surface OS2a as viewed in the front-rear direction. However, as illustrated in FIG. 4, the fourth chamfered portion R4a does not reach the fourth rear surface SB4a. Since the fourth chamfered portion R4a is provided, the thickness of the front-end portion of the second coupling portion PC2a is reduced. The fourth chamfered portion R4a is in contact with the frame portion 11b. Accordingly, the fourth chamfered portion R4a is in contact with the resin body member 11.

The exposed portion PE extends in the right direction from the lower end portion of the main body portion MBa. More specifically, the exposed portion PE extends in the right direction from the lower end portion of the third portion P3a. As illustrated in FIG. 5, the exposed portion PE is exposed from the resin body member 11.

The first ground terminals 16b1 to 16b3 and 16f1 to 16f3 are connected to the ground potential. The first ground terminals 16b1 to 16b3 and 16f1 to 16f3 are supported by the resin body member 11. More specifically, a portion of the first ground terminal 16b1 and a portion of the first ground terminal 16f1 are embedded in the left side of the frame portion 11b. As a result, the first ground terminals 16b1 and 16f1 are arranged in a line in this order from the rear to the front. A portion of the first ground terminal 16b2 is embedded in the rear side of the frame portion 11b. A portion of the first ground terminal 16b3 and a portion of the first ground terminal 16f3 are embedded in the right side of the frame portion 11b. As a result, the first ground terminals 16b3 and 16f3 are arranged in a line in this order from the rear to the front. A portion of the first ground terminal 16f2 is embedded in the front side of the frame portion 11b. The first ground terminals 16b 1 to 16b3 and 16f1 to 16f3 are produced by plate-shaped metal members being bent. The material of the first ground terminals 16b1 to 16b3 and 16f1 to 16f3 is, for example, a copper-based material, such as phosphor bronze.

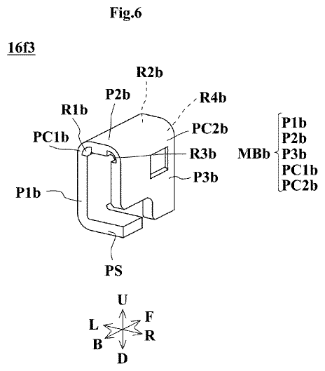

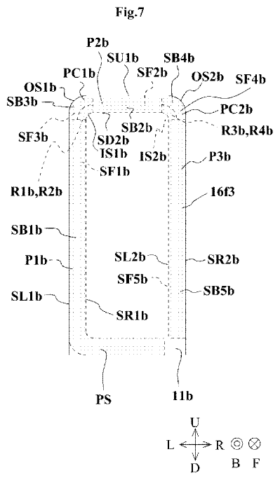

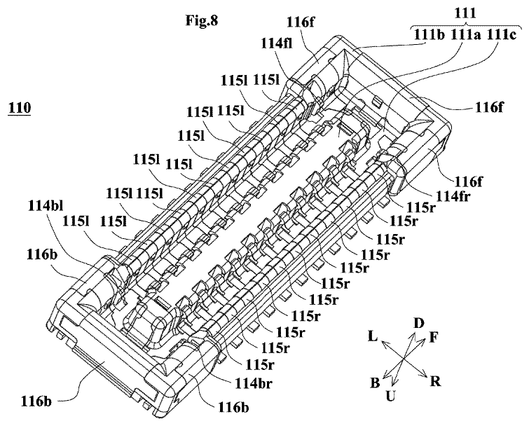

The structure of the first ground terminals 16b1 to 16b3 and 16f1 to 16f3 will be described in detail with reference to the drawings. It should be noted that, since the first ground terminals 16b1 to 16b3 and 16f1 to 16f3 have the same shape, the description of the structure of the first ground terminals 16b1 to 16b3, 16f1, and 16f2 is omitted. FIG. 6 is a perspective view of the first ground terminal 16f3 according to the first embodiment. FIG. 7 is a cross-sectional view of the first ground terminal 16f3 and the frame portion 11b according to the first embodiment.

The first ground terminal 16f3 includes a main body portion MBb and a support portion PS, as illustrated in FIGS. 6 and 7. The main body portion MBb includes a first portion P1b, a second portion P2b, a third portion P3b, a first coupling portion PC1b, and a second coupling portion PC2b.

The first portion P1b has a first left surface SL1b that faces the left direction, a first right surface SR1b that faces the right direction, a first rear surface SB1b and a first front surface SF1b that are arranged in the front-rear direction, and a first lower surface SD1b that faces the downward direction. The first left surface SL1b is not in contact with the resin body member 11. Accordingly, the first left surface SL1b is exposed from the resin body member 11. The first right surface SR1b, the first rear surface SB1b, the first front surface SF1b, and the first lower surface SD1b are in contact with the frame portion 11b. Accordingly, the first right surface SR1b, the first rear surface SB1b, the first front surface SF1b, and the first lower surface SD1b are in contact with the resin body member 11. The first portion P1b extends in the up-down direction. In addition, in the embodiment, the length of the first portion P1b in the left-right direction is uniform.

The second portion P2b is located above the first portion P1b. The second portion P2b has a second rear surface SB2b and a second front surface SF2b that are arranged in the front-rear direction, a first upper surface SU1b that faces the upward direction, and a second lower surface SD2b that faces the downward direction. The first upper surface SU1b is not in contact with the resin body member 11. Accordingly, the first upper surface SU1b is exposed from the resin body member 11. The second rear surface SB2b, the second front surface SF2b, and the second lower surface SD2b are in contact with the frame portion 11b. Accordingly, the second rear surface SB2b, the second front surface SF2b, and the second lower surface SD2b are in contact with the resin body member 11. The second portion P2b extends in the left-right direction. In addition, in the embodiment, the length of the second portion P2b in the up-down direction is uniform.

The third portion P3b is located below the second portion P2b. The third portion P3b has a second left surface SL2b that faces the left direction, a second right surface SR2b that faces the right direction, and a fifth rear surface SB5b and a fifth front surface SF5b that are arranged in the front-rear direction. The second right surface SR2b is not in contact with the resin body member 11. Accordingly, the second right surface SR2b is exposed from the resin body member 11. The second left surface SL2b, the fifth rear surface SB5b, the fifth front surface SF5b, and the second lower surface SD2b are in contact with the frame portion 11b. Accordingly, the second left surface SL2b, the fifth rear surface SB5b, the fifth front surface SF5b, and the second lower surface SD2b are in contact with the resin body member 11. The third portion P3b extends in the up-down direction. In addition, in the embodiment, the length of the third portion P3b in the left-right direction is uniform.

The first coupling portion PC1b physically connects the upper-end portion of the first portion P1b and the left-end portion of the second portion P2b to each other and is bent. The first coupling portion PC1b has a first inner peripheral surface IS1b that faces the lower-right direction, a first outer peripheral surface OS1b that faces the upper-left direction, and a third rear surface SB3b and a third front surface SF3b that are arranged in the front-rear direction. The first inner peripheral surface IS1b is connected to the first right surface SR1b and the second lower surface SD2b. The first outer peripheral surface OS1b is connected to the first left surface SL1b and the first upper surface SU1b. The third rear surface SB3b is connected to the first rear surface SB1b and the second rear surface SB2b. The third front surface SF3b is connected to the first front surface SF1b and the second front surface SF2b. The first outer peripheral surface OS1b is not in contact with the resin body member 11. Accordingly, the first outer peripheral surface OS1b is exposed from the resin body member 11. The first inner peripheral surface IS1b, the third rear surface SB3b, and the third front surface SF3b are in contact with the frame portion 11b. Accordingly, the first inner peripheral surface IS1b, the third rear surface SB3b, and the third front surface SF3b are in contact with the resin body member 11.

The second coupling portion PC2b physically connects the right-end portion of the second portion P2b and the upper-end portion of the third portion P3b to each other and is bent. The second coupling portion PC2b has a second inner peripheral surface IS2b that faces the lower-left direction, a second outer peripheral surface OS2b that faces the upper-right direction, and a fourth rear surface SB4b and a fourth front surface SF4b that are arranged in the front-rear direction. The second inner peripheral surface IS2b is connected to the second lower surface SD2b and the second left surface SL2b. The second outer peripheral surface OS2b is connected to the first upper surface SU1b and the second right surface SR2b. The fourth rear surface SB4b is connected to the second rear surface SB2b and the fifth rear surface SB5b. The fourth front surface SF4b is connected to the second front surface SF2b and the fifth front surface SF5b. The second outer peripheral surface OS2b is not in contact with the resin body member 11. Accordingly, the second outer peripheral surface OS2b is exposed from the resin body member 11. The second inner peripheral surface IS2b, the fourth rear surface SB4b, and the fourth front surface SF4b are in contact with the frame portion 11b. Accordingly, the second inner peripheral surface IS2b, the fourth rear surface SB4b, and the fourth front surface SF4b are in contact with the resin body member 11.

In the embodiment, as illustrated in FIG. 4, a first chamfered portion R1b and a second chamfered portion R2b are provided in the first coupling portion PC1b. In addition, a third chamfered portion R3b and a fourth chamfered portion R4b are provided in the second coupling portion PC2b. It should be noted that the second chamfered portion R2b has a structure that is symmetrical with respect to the first chamfered portion R1b in the front-rear direction. In addition, the fourth chamfered portion R4b has a structure that is symmetrical with respect to the third chamfered portion R3b in the front-rear direction. In the embodiment, the first chamfered portion R1b, the second chamfered portion R2b, the third chamfered portion R3b, and the fourth chamfered portion R4b are not connected to each other.

The third rear surface SB3b is connected to the first inner peripheral surface IS1b via the first chamfered portion R1b. More specifically, the first chamfered portion R1b is recessed in the left direction as viewed in the front-rear direction. In addition, the first chamfered portion R1b is recessed in the forward direction as viewed in the left-right direction. Accordingly, as illustrated in FIG. 7, the first chamfered portion R1b is recessed in the direction from the first inner peripheral surface IS1b to the first outer peripheral surface OS1b as viewed in the front-rear direction. However, as illustrated in FIG. 6, the first chamfered portion R1b does not reach the third front surface SF3b. Since the first chamfered portion R1b is provided, the thickness of the rear-end portion of the first coupling portion PC1b is reduced. The first chamfered portion R1b is in contact with the frame portion 11b. Accordingly, the first chamfered portion R1b is in contact with the resin body

The third front surface SF3b is connected to the first inner peripheral surface IS1b via the second chamfered portion R2b. More specifically, the second chamfered portion R2b is recessed in the left direction as viewed in the front-rear direction. In addition, the second chamfered portion R2b is recessed in the backward direction as viewed in the left-right direction. Accordingly, as illustrated in FIG. 7, the second chamfered portion R2b is recessed in the direction from the first inner peripheral surface IS1b to the first outer peripheral surface OS1b as viewed in the front-rear direction. However, as illustrated in FIG. 6, the second chamfered portion R2b does not reach the third rear surface SB3b. Since the second chamfered portion R2b is provided, the thickness of the front-end portion PC1b of the first coupling portion is reduced. The second chamfered portion R2b is in contact with the frame portion 11b. Accordingly, the second chamfered portion R2b is in contact with the resin body member 11.

The fourth rear surface SB4b is connected to the second inner peripheral surface IS2b via the third chamfered portion R3b. More specifically, the third chamfered portion R3b is recessed in the right direction as viewed in the front-rear direction. In addition, the third chamfered portion R3b is recessed in the forward direction as viewed in the left-right direction. Accordingly, as illustrated in FIG. 7, the third chamfered portion R3b is recessed in the direction from the second inner peripheral surface IS2b to the second outer peripheral surface OS2b as viewed in the front-rear direction. However, as illustrated in FIG. 6, the third chamfered portion R3b does not reach the fourth front surface SF4b. Since the third chamfered portion R3b is provided, the thickness of the rear-end portion of the second coupling portion PC2b is reduced. The third chamfered portion R3b is in contact with the frame portion 11b. Accordingly, the third chamfered portion R3b is in contact with the resin body member 11.

The fourth front surface SF4b is connected to the second inner peripheral surface IS2b via the fourth chamfered portion R4b. More specifically, the fourth chamfered portion R4b is recessed in the right direction as viewed in the front-rear direction. Moreover, the fourth chamfered portion R4b is recessed in the backward direction as viewed in the left-right direction. Accordingly, as illustrated in FIG. 7, the fourth chamfered portion R4b is recessed in the direction from the second inner peripheral surface IS2b to the second outer peripheral surface OS2b as viewed in the front-rear direction. However, as illustrated in FIG. 6, the fourth chamfered portion R4b does not reach the fourth rear surface SB4b. Since the fourth chamfered portion R4b is provided, the thickness of the front-end portion of the second coupling portion PC2b is reduced. The fourth chamfered portion R4b is in contact with the frame portion 11b. Accordingly, the fourth chamfered portion R4b is in contact with the resin body member 11.

The support portion PS extends in the right direction from the lower end portion of the first portion P1b.

In the first connector 10 as described above, the first connector 10 is mounted on the first circuit board (not illustrated) such that the lower surface of the resin body member 11 faces the first circuit board. More specifically, portions of the first signal terminals 151 and 15r and portions of the first ground terminals 16b1, 16b2, 16b3, 16f1, 16f2, and 16f3 are exposed from the lower surface of the resin body member 11. Accordingly, solder is applied to these portions. As a result, portions of the first signal terminals 151 and 15r and the first ground terminals 16b1 to 16b3 and 16f1 to 16f3 are electrically connected to electrodes of the first circuit board.

In the first connector 10, the exposed portion PE extends in the right direction from the lower end portion of the first portion Pla. As a result, the exposed portion PE is located opposite to the second portion P2a as viewed from the first portion Pla. The exposed portion PE is a portion to which solder is applied when the first connector 10 is mounted. On the other hand, the first portion Pla is a portion held by the resin body member 11. As described above, when the first portion Pla is separated from the exposed portion PE, the first portion Pla is easily fixed to the resin body member 11, and the exposed portion PE is easily fixed to the first circuit board.

### [Structure of Second Connector]

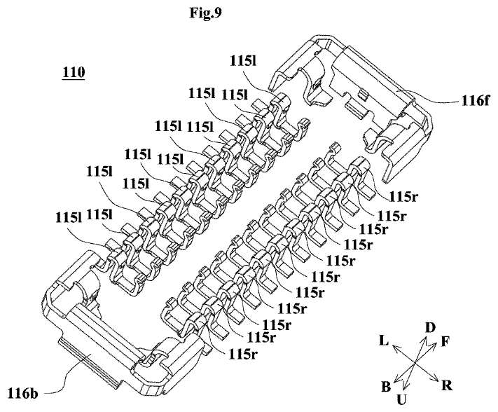

Next, the structure of the second connector 110 will be described with reference to the drawings. FIG. 8 is a perspective view of the second connector 110 according to the first embodiment. FIG. 9 is a perspective view of the second signal terminals 1151 and 115r and the second ground terminals 116b and 116f of the second connector 110 according to the first embodiment.

The second connector 110 includes a resin body member 111, contact terminals 114fl, 114fr, 114bl, and 114br, the second signal terminals 1151 and 115r, and the second ground terminals 116b and 116f, as illustrated in FIGS. 8 and 9. The resin body member 111, the contact terminals 114fl, 114fr, 114bl, and 114br, the second signal terminals 1151 and 115r, and the second ground terminals 116b and 116f are molded integrally with each other by insert molding. The second signal terminals 1151 and 115r and the second ground terminals 116b and 116f correspond to the second outer connection terminals.

The resin body member 111 includes a projecting portion 111a, a frame portion 111b, and a coupling portion 111c, as illustrated in FIG. 8. The projecting portion 111a extends along the front-rear axis as viewed in the upward direction. More specifically, the projecting portion 111a has a rectangular parallelepiped shape. The projecting portion 111a has two long sides that extend along the front-rear axis and two short sides that extend along the left-right axis as viewed in the upward direction.

The frame portion 111b has a loop shape that surrounds the projecting portion 111a as viewed in the upward direction. The frame portion 111b has a left side and a right side that extend along the front-rear axis and a front side and a rear side that extend along the left-right axis. In addition, the projecting portion 111a is located within the region surrounded by the frame portion 111b as viewed in the downward direction. The projecting portion 111a is not in contact with the frame portion 111b.

The coupling portion 111c is located between the projecting portion 111a and the frame portion 111b as viewed in the upward direction and couples the projecting portion 111a and the frame portion 111b to each other. The coupling portion 111c connects the upper portion of the projecting portion 111a and the upper portion of the frame portion 111b to each other. The material of the resin body member 111 is an insulating material. The material of the resin body member 111 is, for example, a resin.

The contact terminals 114fl, 114fr, 114bl, and 114br are connected to the ground potential. The contact terminals 114fl, 114fr, 114bl, and 114br are supported by the resin body member 111. More specifically, the contact terminal 114fl is supported by the left side of the frame portion 111b. The contact terminal 114fr is supported by the right side of the frame portion 111b. The contact terminal 114bl is supported by the left side of the frame portion 111b. The contact terminal 114br is supported by the right side of the frame portion 111b. The material of the contact terminals 114fl, 114fr, 114bl, and 114br is a copper-based material, such as phosphor bronze.

High-frequency signals are input or output through the second signal terminals 1151 and 115r. The second signal terminals 1151 and 115r are supported by the resin body member 111. More specifically, portions of the second signal terminals 1151 are embedded in the left side of the frame portion 111b. The second signal terminals 1151 are arranged in a line along the front-rear axis. Portions of the second signal terminal 115r are embedded in the right side of the frame portion 111b. The second signal terminals 115r are arranged in a line along the front-rear axis. The second signal terminals 1151 and 115r are produced by rod-shaped metal members being bent. The material of the second signal terminals 1151 and 115r is, for example, a copper-based material, such as phosphor bronze.

The second ground terminals 116b and 116f are connected to the ground potential. The second ground terminals 116b and 116f are supported by the resin body member 111. More specifically, a portion of the second ground terminal 116b is embedded in the rear-end portion of the frame portion 111b. A portion of the second ground terminal 116b is embedded in the front-end portion of the frame portion 111b. The second ground terminals 116b and 116f are produced by rod-shaped metal members being bent. The material of the second ground terminals 116b and 116f is, for example, a copper-based material, such as phosphor bronze.

In the second connector 110 as described above, the second connector 110 is mounted on the second circuit board (not illustrated) such that the upper surface of the resin body member 111 faces the second circuit board. More specifically, portions of the contact terminals 114fl, 114fr, 114bl, and 114br, portions of the second signal terminals 1151 and 115r, and portions of the second ground terminals 116b and 116f are exposed from the upper surface of the resin body member 11. Accordingly, solder is applied to these portions. As a result, the contact terminals 114fl, 114fr, 114bl, and 114br, the second signal terminals 1151 and 115r, and the second ground terminals 116b and 116f are electrically connected to electrodes of the second circuit board.

The frame portion 11b of the first connector 10 is inserted into the region surrounded by the frame portion 111b of the second connector 110. At this time, the projecting portion 111a of the second connector 110 is inserted into the region surrounded by the frame portion 11b of the first connector 10. As a result, when the first connector 10 and the second connector 110 are coupled to each other, the first ground terminals 16b1 to 16b3 come into contact with the second ground terminals 116b and the contact terminals 114bl and 114br. When the first connector 10 and the second connector 110 are coupled to each other, the first ground terminals 16f1 to 16f3 come into contact with the second ground terminals 116f and the contact terminals 114fl and 114fr. When the first connector 10 and the second connector 110 are coupled to each other, the first signal terminals 151 come into contact with the second signal terminals 1151. When the first connector 10 and the second connector 110 are coupled to each other, the first signal terminals 15r come into contact with the second signal terminals 115r.

### Effects

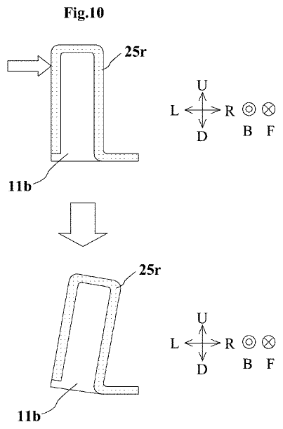

The first connector 10 can suppress the concentration of stress on portions of the terminals when coupled to the mating connector. This will be described by using the first signal terminal 15r as an example. As a comparative example, the first signal terminal 25r not having the first chamfered portion R1a, the second chamfered portion R2a, the third chamfered portion R3a, or the fourth chamfered portion R4a will be described with reference to the drawings. FIG. 10 is a cross-sectional view illustrating the damage to the resin body member 11 caused by contact between the first signal terminal 25r and the second signal terminal 115r. A resin body member 11 is present between adjacent first signal terminals 25r. When the first connector 10 and the second connector 110 are coupled to each other, the first signal terminals 25r come into contact with the second signal terminal 115r. As a result, the first signal terminals 25r receive a force in the right direction from the second signal terminals 115r. As a result, stress is concentrated on the intersection line between the third rear surface SB3a and the first inner peripheral surface IS1a, the intersection line between the third front surface SF3a and the first inner peripheral surface IS1a, the intersection line between the fourth rear surface SB4a and the first inner peripheral surface IS1a, and the intersection line between the fourth front surface SF4a and the first inner peripheral surface IS1a. In this case, the resin body member 11 may be damaged. As a result, as illustrated in FIG. 10, the portion surrounded by the first signal terminal 25r of the resin body member 11 may tilt in the right direction along with the first signal terminal 15r.

Accordingly, in the first connector 10, the third rear surface SB3a is connected to the first inner peripheral surface IS1a via the first chamfered portion R1a. As a result, the portion on which stress concentrates changes from the intersection line (line) between the third rear surface SB3a and the first inner peripheral surface IS1a to the first chamfered portion R1a (surface), and accordingly, the stress can be distributed. The third front surface SF3a is connected to the first inner peripheral surface IS1a via the second chamfered portion R2a. As a result, the portion on which stress concentrates changes from the intersection line (line) between the third front surface SF3a and the first inner peripheral surface IS1a to the second chamfered portion R2a (surface), and accordingly, the stress can be distributed. The fourth rear surface SB4a is connected to the second inner peripheral surface IS2a via the third chamfered portion R3a. As a result, the portion on which stress concentrates changes from the intersection line (line) between the fourth rear surface SB4a and the first inner peripheral surface IS1a to the third chamfered portion R3a (surface), and accordingly, the stress can be distributed. The fourth front surface SF4a is connected to the second inner peripheral surface IS2a via the fourth chamfered portion R4a. As a result, the portion on which stress concentrates changes from the intersection line (line) between the fourth front surface SF4a and the first inner peripheral surface IS1a to the fourth chamfered portion R4a (surface), and accordingly, the stress can be distributed. Accordingly, the first connector 10 can further suppress the concentration of stress on portions of the terminals when coupled to the mating connector.

In addition, in the first connector 10, the size of the first signal terminal in the left-right direction can be reduced. More specifically, the first chamfered portion R1a and the second chamfered portion R2a are recessed in the direction from the first inner peripheral surface IS1a to the first outer peripheral surface OS1a as viewed in the front-rear direction. In addition, the third chamfered portion R3a and the fourth chamfered portion R4a are recessed in the direction from the second inner peripheral surface IS2a to the second outer peripheral surface OS2a as viewed in the front-rear direction. In addition, the first chamfered portion R1a, the second chamfered portion R2a, the third chamfered portion R3a, and the fourth chamfered portion R4a are in contact with the resin body member 11. As a result, as viewed in the up-down direction, the contact area between the first signal terminal 15r and the resin body member 11 in the region that overlaps the first signal terminal 15r can be increased. Accordingly, the first signal terminal 15r can increase the strength against the shear stress acting on the contact point between the first signal terminal 15r and the resin body member 11. Accordingly, even when the size of the first signal terminal 15r in the left-right direction is reduced, the strength against the shear stress acting on the contact point between the first signal terminal 15r and the resin body member 11 can be ensured. As a result, in the first connector 10, the size of the first signal terminal in the left-right direction can be reduced.

In addition, in the first connector 10, the pitch between first signal terminals can be reduced. More specifically, since the first chamfered portion R1a, the second chamfered portion R2a, the third chamfered portion R3a, and the fourth chamfered portion R4a are provided, the average distance between adjacent first signal terminals 15r in the front-rear direction is increased, and accordingly, the capacitance generated between adjacent first signal terminals 15r is reduced. As a result, the resonant frequency between adjacent first signal terminals 15r increases. Accordingly, even when the pitch between the first signal terminals is reduced, the effects of the high-frequency signal input or output through the first signal terminals 15r on the high-frequency characteristics can be suppressed. As a result, in the first connector 10, the pitch between first signal terminals can be reduced.

### First Modification

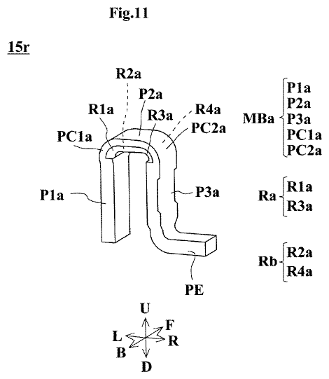

The first signal terminals 15r according to a first modification of the present disclosure will be described below with reference to the drawings. FIG. 11 is a perspective view of the first signal terminal 15r according to the first modification. It should be noted that only the difference between the first signal terminal 15r according to the first modification and the first signal terminal 15r according to the first embodiment will be described and the rest will not be described.

As illustrated in FIG. 11, the first signal terminal 15r according to the first modification differs from the first signal terminal 15r according to the first embodiment in that the first chamfered portion R1a is connected to the third chamfered portion R3a, and the second chamfered portion R2a is connected to the fourth chamfered portion R4a.

More specifically, a chamfered portion Ra is formed by the first chamfered portion R1a and the third chamfered portion R3a being connected to each other. The chamfered portion Ra includes the first chamfered portion R1a and the third chamfered portion R3a. A chamfered portion Rb is formed by the second chamfered portion R2a and the fourth chamfered portion R4a being connected to each other. The chamfered portion Rb includes the second chamfered portion R2a and the fourth chamfered portion R4a.

The second rear surface SB2a is connected to the second lower surface SD2a via the chamfered portion Ra. The second front surface SF2a is connected to the second lower surface SD2a via the chamfered portion Rb.

A first connector 10a including the first signal terminals 15r according to the first modification as described above also has the same effect as the first connector 10.

### Second Modification

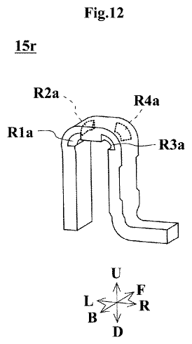

The first signal terminals 15r according to a second modification of the present disclosure will be described below with reference to the drawings. FIG. 12 is a cross-sectional view of the first chamfered portion R1a, the second chamfered portion R2a, the third chamfered portion R3a, and the fourth chamfered portion R4a according to the second modification, as viewed in the left direction. It should be noted that only the difference between the first signal terminal 15r according to the second modification and the first signal terminal 15r according to the first embodiment will be described and the rest will not be described.

As illustrated in FIG. 12, the first signal terminal 15r according to the second modification differs from the first signal terminal 15r according to the first embodiment in that the lengths of the first chamfered portion R1a and the third chamfered portion R3a in the left-right direction increase toward the rear, and the lengths of the second chamfered portion R2a and the fourth chamfered portion R4a in the left-right direction increase toward the front.

A first connector 10b including the first signal terminals 15r according to the second modification as described above also has the same effect as the first connector 10. In addition, in the first connector 10b, the first signal terminals can be suppressed from being detached from the resin body member. The length of the first chamfered portion R1a in the left-right direction increases toward the rear. As a result, when a force in the backward direction is applied to the first signal terminal 15r, the first coupling portion PC1 catches on the resin body member 11. The length of the second chamfered portion R2a in the left-right direction increases toward the front. As a result, when a force in the forward direction is applied to the first signal terminal 15r, the first coupling portion PC1 catches on the resin body member 11. In addition, the length of the third chamfered portion R3a in the left-right direction increases toward the rear. As a result, when a force in the backward direction is applied to the first signal terminal 15r, the second coupling portion PC2 catches on the resin body member 11. In addition, the length of the fourth chamfered portion R4a in the left-right direction increases toward the front. As a result, when a force in the forward direction is applied to the first signal terminal 15r, the second coupling portion PC2 catches on the resin body member 11. Accordingly, in the first connector 10b, the first signal terminals can be suppressed from being detached from the resin body member.

### Third Modification

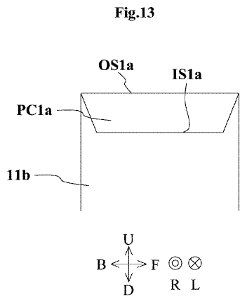

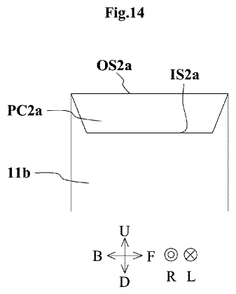

The first signal terminals 15r according to the third modification of the present disclosure will be described below with reference to the drawings. FIG. 13 is a cross-sectional view of the right end of the first coupling portion PCla and the frame portion 11b according to the third modification, as viewed in the left direction. FIG. 14 is a cross-sectional view of the left end of the second coupling portion PC2a and the frame portion 11b according to the third modification, as viewed in the left direction. It should be noted that only the difference between the first signal terminal 15r according to the third modification and the first signal terminal 15r according to the first embodiment will be described and the rest will not be described.

The first signal terminal 15r according to the third modification differs from the first signal terminal 15r according to the first embodiment in that the length of the first inner peripheral surface IS1a in the front-rear direction is smaller than the length of the first outer peripheral surface OS1a in the front-rear direction, and the length of the second inner peripheral surface IS2a in the front-rear direction is smaller than the length of the second outer peripheral surface OS2a in the front-rear direction. As a result, as illustrated in FIG. 13, at the right end of the first coupling portion PCla, the length of the first inner peripheral surface IS1a in the front-rear direction is smaller than the length of the first outer peripheral surface OS1a in the front-rear direction. In addition, as illustrated in FIG. 14, at the left end of the second coupling portion PC2a, the length of the second inner peripheral surface IS2a in the front-rear direction is smaller than the length of the second outer peripheral surface OS2a in the front-rear direction.

The first connector 10c including the first signal terminals 15r according to the third modification as described above also has the same effect as the first connector 10. In addition, the first connector 10c can further suppress the concentration of stress on portions of the terminals when coupled to the mating connector.

### [Fourth Modification]

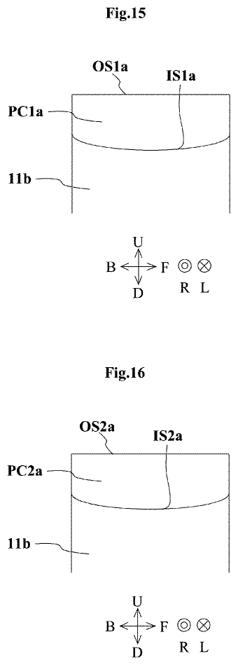

The first signal terminals 15r according to the fourth modification of the present disclosure will be described with reference to the drawings. FIG. 15 is a cross-sectional view of the right end of the first coupling portion PCla and the frame portion 11b according to the fourth modification, as viewed in the left direction. FIG. 16 is a cross-sectional view of the left end of the second coupling portion PC2a and the frame portion 11b according to the fourth modification, as viewed in the left direction. It should be noted that only the difference between the first signal terminal 15r according to the fourth modification and the first signal terminal 15r according to the first embodiment will be described and the rest will not be described.

The first signal terminal 15r according to the fourth modification differs from the first signal terminal 15r according to the first embodiment in that the length of the first inner peripheral surface IS1a in the front-rear direction is smaller than the length of the first outer peripheral surface OS1a in the front-rear direction, and the length of the second inner peripheral surface IS2a in the front-rear direction is smaller than the length of the second outer peripheral surface OS2a in the front-rear direction. More specifically, as illustrated in FIGS. 15 and 16, the right end of the first inner peripheral surface IS1a has an arc shape that projects in the downward direction as viewed in the left-right direction. The right end of the second inner peripheral surface IS2a has an arc shape that projects in the downward direction as viewed in the left-right direction.

The first connector 10d including the first signal terminals 15r according to the fourth modification as described above also has the same effect as the first connector 10. In addition, the first connector 10d can further suppress the concentration of stress on portions of the terminals when coupled to the mating connector.

### Other Embodiments

The first connectors according to the present disclosure are not limited to the first connectors 10 and 10a to 10d and can be changed within the scope of the spirit. In addition, the structure of the first connectors 10 and 10a to 10d may be arbitrarily combined with each other.

It should be noted that the number of first signal terminals only needs to be one or more.

It should be noted that the first connectors 10 and 10a to 10d do not need to include the first ground terminals 16b1 to 16b3 and 16f1 to 16f3. In addition, when the first connectors 10 and 10a to 10d include the first ground terminals, the number of the first ground terminals only needs to be one or more.

It should be noted that the resin body member 11, the first signal terminals 151 and 15r, and the first ground terminals 16b1 to 16b3 and 16f1 to 16f3 may be molded by press molding.

It should be noted that the first ground terminals 16b1 to 16b3 and 16fl to 16f3 do not need to have the same shape.

It should be noted that at least one of the first chamfered portion R1a, the second chamfered portion R2a, the third chamfered portion R3a, and the fourth chamfered portion R4a only needs to be provided in the first coupling portion PCla or the second coupling portion PC2a. That is, for example, the first chamfered portion R1a or the second chamfered portion R2a may be provided in the first coupling portion PCla without the third chamfered portion R3a or the fourth chamfered portion R4a being provided in the second coupling portion PC2a. Alternatively, the third chamfered portion R3a or the fourth chamfered portion R4a may be provided in the second coupling portion PC2a without the first chamfered portion R1a or the second chamfered portion R2a being provided in the first coupling portion PCla.

It should be noted that the chamfered portion Ra does not need to include the first chamfered portion R1a or the third chamfered portion R3a. The second rear surface SB2a may be connected to the second lower surface SD2a via the chamfered portion Ra.

It should be noted that the chamfered portion Rb does not need to include the second chamfered portion R2a or the fourth chamfered portion R4a. The second front surface SF2a may be connected to the second lower surface SD2a via the chamfered portion Rb.

It should be noted that at least one of the first chamfered portion R1b, the second chamfered portion R2b, the third chamfered portion R3b, and the fourth chamfered portion R4b only needs to be provided in the first coupling portion PC1b or the second coupling portion PC2b. That is, the first chamfered portion R1b or the second chamfered portion R2b may be provided in the first coupling portion PC1b without the third chamfered portion R3b or the fourth chamfered portion R4b being provided in the second coupling portion PC2b. Alternatively, the third chamfered portion R3b and the fourth chamfered portion R4b may be provided in the second coupling portion PC2b without the first chamfered portion R1b or the second chamfered portion R2b being provided in the first coupling portion PC1b.

It should be noted that the lengths of the first portions Pla and P1b in the left-right direction do not need to be uniform.

It should be noted that the lengths of the second portions P2a and P2b in the up-down direction do not need to be uniform.

It should be noted that the lengths of the third portions P3a and P3b in the left-right direction do not need to be uniform.

It should be noted that the first chamfered portion R1b may be connected to the third chamfered portion R3a. A chamfered portion Rc may be formed by the first chamfered portion R1b and the third chamfered portion R3b being connected to each other. The chamfered portion Rc may include the first chamfered portion R1b and the third chamfered portion R3b or does not need to include the first chamfered portion R1b or the third chamfered portion R3b. The second rear surface SB2b may be connected to the second lower surface SD2b via the chamfered portion Rc.

It should be noted that the second chamfered portion R2b may be connected to the fourth chamfered portion R4b. A chamfered portion Rd may be formed by the second chamfered portion R2b and the fourth chamfered portion R4b being connected to each other. The chamfered portion Rd may include the second chamfered portion R2b and the fourth chamfered portion R4b or does not need to include the second chamfered portion R2b or the fourth chamfered portion R4b. The second front surface SF2b may be connected to the second lower surface SD2b via the chamfered portion Rd.

It should be noted that the length of the first chamfered portion R1b in the left-right direction may increase toward the rear. In addition, the length of the second chamfered portion R2b in the left-right direction may increase toward the front. In addition, the length of the third chamfered portion R3b in the left-right direction may increase toward the rear. In addition, the length of the fourth chamfered portion R4b in the left-right direction may increase toward the front.

It should be noted that the length of the first outer peripheral surface OS1b in the front-rear direction may be larger than the length of the first inner peripheral surface IS1b in the front-rear direction. In addition, the length of the second outer peripheral surface OS2b in the front-rear direction may be larger than the length of the second inner peripheral surface IS2b in the front-rear direction.

It should be noted that the right end of the first inner peripheral surface IS1b may have an arc shape that project in the downward direction as viewed in the left-right direction. The right end of the second inner peripheral surface IS2b may have an arc shape that projects in the downward direction as viewed in the left-right direction.

The present disclosure has the following structure.
(1) A connector comprising a resin body member; and one or more first outer connection terminals supported by the resin body member. The one or more first outer connection terminals each include a main body portion including a first portion that extends in an up-down direction, a second portion, located above the first portion, that extends in a left-right direction, a third portion, located below the second portion, that extends in the up-down direction, a first coupling portion that is bent and physically connects an upper-end portion of the first portion and a left-end portion of the second portion to each other, and a second coupling portion that is bent and physically connects a right-end portion of the second portion and an upper-end portion of the third portion to each other. The second portion has a lower surface, a first front surface, and a first rear surface. The first portion has a right surface. The first coupling portion has a first inner peripheral surface that faces a lower-right direction, a second front surface, and a second rear surface. The second coupling portion has a second inner peripheral surface that faces a lower-left direction, a third front surface, and a third rear surface. The third portion has a left surface. The first front surface or the first rear surface is connected to the lower surface via one or more chamfered portions, the second front surface or the second rear surface is connected to the first inner peripheral surface via one or more chamfered portions, or the third front surface or the third rear surface is connected to the second inner peripheral surface via one or more chamfered portions. Also, the right surface, the lower surface, the left surface, the one or more chamfered portions, and the first inner peripheral surface or the second inner peripheral surface are in contact with the resin body member.
(2) The connector according to (1), wherein the first inner peripheral surface is in contact with the resin body member, and the second front surface or the second rear surface is connected to the first inner peripheral surface via the one or more chamfered portions.
(3) The connector according to (1) or (2), wherein the second inner peripheral surface is in contact with the resin body member, and the third front surface or the third rear surface is connected to the second inner peripheral surface via the one or more chamfered portions.
(4) The connector according to any one of (1) to (3), wherein the first coupling portion has a first outer peripheral surface that faces an upper-left direction and the one or more chamfered portions are recessed toward the first outer peripheral surface from the first inner peripheral surface as viewed in a front-rear direction, or the second coupling portion has a second outer peripheral surface that faces an upper-right direction and the one or more chamfered portions are recessed toward the second outer peripheral surface from the second inner peripheral surface as viewed in the front-rear direction.
(5) The connector according to any one of (1) to (4), wherein the one or more chamfered portions include a first chamfered portion and a second chamfered portion, the first chamfered portion is recessed in a left direction as viewed in a front-rear direction and is recessed in a forward direction as viewed in the left-right direction, the second chamfered portion is recessed in the left direction as viewed in the front-rear direction and is recessed in a backward direction as viewed in the left-right direction, the first chamfered portion is provided so as to straddle the second rear surface and the first inner peripheral surface, and the second chamfered portion is provided so as to straddle the second front surface and the first inner peripheral surface.
(6) The connector according to any one of (1) to (5), wherein the one or more chamfered portions include a first chamfered portion and a third chamfered portion, the first chamfered portion is recessed in a left direction as viewed in a front-rear direction and is recessed in a forward direction as viewed in the left-right direction, the third chamfered portion is recessed in a right direction as viewed in the front-rear direction and is recessed in the forward direction as viewed in the left-right direction, the first chamfered portion is provided so as to straddle the second rear surface and the first inner peripheral surface, and the third chamfered portion is provided so as to straddle the third rear surface and the second inner peripheral surface.
(7) The connector according to (6), wherein the first chamfered portion is connected to the third chamfered portion.
(8) The connector according to any one of (1) to (7), wherein the one or more chamfered portions include a third chamfered portion and a fourth chamfered portion, the third chamfered portion is recessed in a right direction as viewed in a front-rear direction and is recessed in a forward direction as viewed in the left-right direction, the fourth chamfered portion is recessed in the right direction as viewed in the front-rear direction and is recessed in a backward direction as viewed in the left-right direction, the third chamfered portion is provided so as to straddle the third rear surface and the second inner peripheral surface, and the fourth chamfered portion is provided so as to straddle the third front surface and the second inner peripheral surface.
(9) The connector according to any one of (1) to (8), wherein the one or more chamfered portions include a second chamfered portion and a fourth chamfered portion, the second chamfered portion is recessed in a left direction as viewed in a front-rear direction and is recessed in a backward direction as viewed in the left-right direction, the fourth chamfered portion is recessed in a right direction as viewed in the front-rear direction and is recessed in the backward direction as viewed in the left-right direction, the second chamfered portion is provided so as to straddle the second front surface and the first inner peripheral surface, and the fourth chamfered portion is provided so as to straddle the third front surface and the second inner peripheral surface.
(10) The connector according to (9) wherein the second chamfered portion is connected to the fourth chamfered portion.
(11) The connector according to any one of (1) to (10), wherein the first coupling portion has a first outer peripheral surface that faces an upper-left direction, the first inner peripheral surface is in contact with the resin body member, and a length of the first inner peripheral surface in a front-rear direction is smaller than a length of the first outer peripheral surface in the front-rear direction.
(12) The connector according to any one of (1) to (11), wherein a right end of the first inner peripheral surface has an arc shape that projects in a downward direction as viewed in the left-right direction.
(13) The connector according to any one of (1) to (12), wherein the second coupling portion has a second outer peripheral surface that faces an upper-right direction, the second inner peripheral surface is in contact with the resin body member, and a length of the second inner peripheral surface in a front-rear direction is smaller than a length of the second outer peripheral surface in the front-rear direction.
(14) The connector according to any one of (1) to (13), wherein a left end of the second inner peripheral surface has an arc shape that projects in a downward direction as viewed in the left-right direction.
(15) The connector according to any one of (1) to (14), wherein a length of the chamfered portion in the left-right direction increases toward a rear.
(16) The connector according to any one of (1) to (14), wherein a length of the one or more chamfered portions in the left-right direction increases toward a front.
(17) A connector set comprising the connector according to any one of (1) to (16); and a second connector including one or more second outer connection terminals. When the connector and the second connector are coupled to each other, the connector is located below the second connector, and the first outer connection terminal is in contact with the second outer connection terminal.

What is claimed is:

1. A connector comprising:
a resin body member; and
one or more first outer connection terminals supported by the resin body member,
wherein
the one or more first outer connection terminals each include
a main body portion including
a first portion that extends in an up-down direction,
a second portion, above the first portion, that extends in a left-right direction,
a third portion, below the second portion, that extends in the up-down direction,
a first coupling portion that is bent and physically connects an upper-end portion of the first portion and a left-end portion of the second portion to each other, and
a second coupling portion that is bent and physically connects a right-end portion of the second portion and an upper-end portion of the third portion to each other,
the second portion has a lower surface, a second front surface, and a second rear surface,
the first portion has a right surface,
the first coupling portion has a first inner peripheral surface that faces a lower-right direction, a third front surface, and a third rear surface,
the second coupling portion has a second inner peripheral surface that faces a lower-left direction, a fourth front surface, and a fourth rear surface,
the third portion has a left surface,
the second front surface or the second rear surface is connected to the lower surface via one or more chamfered portions, the third front surface or the third rear surface is connected to the first inner peripheral surface via one or more chamfered portions, or the fourth front surface or the fourth rear surface is connected to the second inner peripheral surface via one or more chamfered portions, and
the right surface, the lower surface, the left surface, the one or more chamfered portions, and the first inner peripheral surface or the second inner peripheral surface are in contact with the resin body member.

2. The connector according to claim 1, wherein
the first inner peripheral surface is in contact with the resin body member, and
the third front surface or the third rear surface is connected to the first inner peripheral surface via the one or more chamfered portions.

3. The connector according to claim 1, wherein
the second inner peripheral surface is in contact with the resin body member, and
the fourth front surface or the fourth rear surface is connected to the second inner peripheral surface via the one or more chamfered portions.

4. The connector according to claim 1, wherein
the first coupling portion has a first outer peripheral surface that faces an upper-left direction and the one or more chamfered portions are recessed toward the first outer peripheral surface from the first inner peripheral surface as viewed in a front-rear direction, or the second coupling portion has a second outer peripheral surface that faces an upper-right direction and the one or more chamfered portions are recessed toward the second outer peripheral surface from the second inner peripheral surface as viewed in the front-rear direction.

5. The connector according to claim 1, wherein
the one or more chamfered portions include a first chamfered portion and a second chamfered portion,
the first chamfered portion is recessed in a left direction as viewed in a front-rear direction and is recessed in a forward direction as viewed in the left-right direction,
the second chamfered portion is recessed in the left direction as viewed in the front-rear direction and is recessed in a backward direction as viewed in the left-right direction,
the first chamfered portion straddles the third rear surface and the first inner peripheral surface, and
the second chamfered portion straddles the third front surface and the first inner peripheral surface.

6. The connector according to claim 1, wherein
the one or more chamfered portions include a first chamfered portion and a third chamfered portion,
the first chamfered portion is recessed in a left direction as viewed in a front-rear direction and is recessed in a forward direction as viewed in the left-right direction,
the third chamfered portion is recessed in a right direction as viewed in the front-rear direction and is recessed in the forward direction as viewed in the left-right direction,
the first chamfered portion straddles the third rear surface and the first inner peripheral surface, and
the third chamfered portion straddles the fourth rear surface and the second inner peripheral surface.

7. The connector according to claim 6, wherein
the first chamfered portion is connected to the third chamfered portion.

8. The connector according to claim 1, wherein
the one or more chamfered portions include a third chamfered portion and a fourth chamfered portion,
the third chamfered portion is recessed in a right direction as viewed in a front-rear direction and is recessed in a forward direction as viewed in the left-right direction,
the fourth chamfered portion is recessed in the right direction as viewed in the front-rear direction and is recessed in a backward direction as viewed in the left-right direction,
the third chamfered portion straddles the fourth rear surface and the second inner peripheral surface, and
the fourth chamfered portion straddles the fourth front surface and the second inner peripheral surface.

9. The connector according to claim 1, wherein
the one or more chamfered portions include a second chamfered portion and a fourth chamfered portion,
the second chamfered portion is recessed in a left direction as viewed in a front-rear direction and is recessed in a backward direction as viewed in the left-right direction,
the fourth chamfered portion is recessed in a right direction as viewed in the front-rear direction and is recessed in the backward direction as viewed in the left-right direction,
the second chamfered portion straddles the third front surface and the first inner peripheral surface, and
the fourth chamfered portion straddles the fourth front surface and the second inner peripheral surface.

10. The connector according to claim 9, wherein
the second chamfered portion is connected to the fourth chamfered portion.

11. The connector according to claim 1, wherein
the first coupling portion has a first outer peripheral surface that faces an upper-left direction,
the first inner peripheral surface is in contact with the resin body member, and
a length of the first inner peripheral surface in a front-rear direction is smaller than a length of the first outer peripheral surface in the front-rear direction.

12. The connector according to claim 1, wherein
a right end of the first inner peripheral surface has an arc shape that projects in a downward direction as viewed in the left-right direction.

13. The connector according to claim 1, wherein
the second coupling portion has a second outer peripheral surface that faces an upper-right direction,
the second inner peripheral surface is in contact with the resin body member, and
a length of the second inner peripheral surface in a front-rear direction is smaller than a length of the second outer peripheral surface in the front-rear direction.

14. The connector according to claim 1, wherein
a left end of the second inner peripheral surface has an arc shape that projects in a downward direction as viewed in the left-right direction.

15. The connector according to claim 1, wherein
a length of the one or more chamfered portions in the left-right direction increases toward a rear.

16. The connector according to claim 1, wherein
a length of the one or more chamfered portions in the left-right direction increases toward a front.

17. A connector set comprising:
the connector according to claim 1; and
a second connector including one or more second outer connection terminals,
wherein, when the connector and the second connector are coupled to each other, the connector is below the second connector, and the first outer connection terminal is in contact with the second outer connection terminal.

18. The connector according to claim 2, wherein
the second inner peripheral surface is in contact with the resin body member, and
the fourth front surface or the fourth rear surface is connected to the second inner peripheral surface via the one or more chamfered portions.

19. The connector according to claim 2, wherein
the first coupling portion has a first outer peripheral surface that faces an upper-left direction and the one or more chamfered portions are recessed toward the first outer peripheral surface from the first inner peripheral surface as viewed in a front-rear direction, or the second coupling portion has a second outer peripheral surface that faces an upper-right direction and the one or more chamfered portions are recessed toward the second outer peripheral surface from the second inner peripheral surface as viewed in the front-rear direction.

20. The connector according to claim 2, wherein
the one or more chamfered portions include a first chamfered portion and a second chamfered portion,
the first chamfered portion is recessed in a left direction as viewed in a front-rear direction and is recessed in a forward direction as viewed in the left-right direction,
the second chamfered portion is recessed in the left direction as viewed in the front-rear direction and is recessed in a backward direction as viewed in the left-right direction,
the first chamfered portion straddles the third rear surface and the first inner peripheral surface, and
the second chamfered portion straddles the third front surface and the first inner peripheral surface.
